(19) United States
(12) Patent Application Publication
(10) Pub. No.: US 2025/0037730 A1
(43) Pub. Date: Jan. 30, 2025

(54) SPEECH ENHANCEMENT METHOD AND APPARATUS

(71) Applicant: EVOCO LABS CO., LTD., Shanghai (CN)

(72) Inventors: Congxi LU, Shanghai (CN); Linkai LI, Shanghai (CN); Haoshuai ZHOU, Shanghai (CN); Yufan YUAN, Shanghai (CN); Hongcheng SUN, Shanghai (CN)

(21) Appl. No.: 18/711,866

(22) PCT Filed: Oct. 31, 2022
(86) PCT No.: PCT/CN2022/128734

§ 371 Date: Jul. 17, 2024

(30) Foreign Application Priority Data
Nov. 18, 2021 (CN) 202111368857.5

(51) Int. Cl. G10L 21/0232; G10L 25/21; G10L 25/24; G10L 25/60

(52) U.S. Cl. CPC G10L 21/0232; G10L 25/21; G10L 25/24; G10L 25/60

(57) ABSTRACT

This application discloses a speech enhancement method (100, 200) and device. The speech enhancement method (100, 200) includes: receiving a current audio input signal having a speech portion and a non-speech portion (201); determining a voice feature of the speech portion in the current audio input signal (202); determining a speech quality of the current audio input signal (203); evaluating whether the speech quality meets a predetermined speech quality requirement (204); and creating or updating, in response to the speech quality meeting the predetermined speech quality requirement, a reference speech feature by using the voice feature, where the reference speech feature is used for enhancing the speech portion in an audio input signal (205).

### TECHNICAL FIELD

This application relates to the field of audio processing technologies, and more specifically, to a speech enhancement method and device.

### BACKGROUND OF THE INVENTION

Hearing assistance devices (also referred to as “hearing aids”) are widely used for hearing compensation of hearing-disabled patients. The hearing assistance devices may amplify a sound that cannot be heard by the hearing-disabled patients, and use residual hearing of the hearing-disabled patients to enable the sound to be sent to an auditory center of a brain, so that the patients can perceive the sound.

Speech enhancement devices such as hearing aids generally need to amplify speech signals in the sound by using a speech enhancement technology. In the existing speech enhancement technology, a single-pass speech enhancement algorithm is mainly used. To be specific, after each sound input, the hearing aid directly runs a related speech enhancement algorithm to process the sound input. To reduce a delay, most real-time speech enhancement algorithms (in particular, deep learning-based algorithms) use a system design of feature extraction-model operations. However, in some cases, a speech signal quality in an input sound is poor, and a speech enhancement system may be unable to extract sufficient features for speech enhancement. If speech enhancement is performed based on such sound feature, it is often difficult to achieve a satisfactory speech enhancement effect.

Therefore, it is necessary to provide a new speech enhancement method to resolve the technical problems in the prior art.

### SUMMARY OF THE INVENTION

An objective of this application is to provide a speech enhancement method and device, and a storage medium that can improve a speech enhancement effect when the speech signal quality is poor.

The inventor of this application found that many systems that use speech enhancement are related to people with which a user is familiar. For example, a voice call scenario mostly involves a call with a family member, a colleague, or a friend. Therefore, if a feature memory system can be added during feature extraction on a speech signal, and in particular, sound features of a person with which the user is familiar are extracted and recorded, the extracted features help a speech enhancement algorithm better improve the speech enhancement effect.

For example, during a call between the user of a call device and a person with which the user is familiar, if speech features of the person in a quiet environment are known, when the person enters a noisy environment and converses with the user, a speech enhancement algorithm used by the call device may use the speech features extracted in the quiet environment. This helps improve the speech enhancement effect.

According to an aspect of this application, a speech enhancement method is provided. The method includes: receiving a current audio input signal having a speech portion and a non-speech portion; determining a speech feature of the speech portion in the current audio input signal; determining a speech quality of the current audio input signal; evaluating whether the speech quality meets a predetermined speech quality requirement; and creating or updating, in response to the speech quality meeting the predetermined speech quality requirement, a reference speech feature by using the speech feature, where the reference speech feature is used for enhancing the speech portion in an audio input signal.

In some embodiments, the determining the speech quality of the current audio input signal includes: determining a speech signal-to-noise ratio of the current audio input signal, wherein the speech signal-to-noise ratio represents a ratio of a power of the speech portion to a power of the non-speech portion.

In some embodiments, the evaluating whether the speech quality meets the predetermined speech quality requirement includes: comparing the speech signal-to-noise ratio with a predetermined speech signal-to-noise ratio threshold; and determining that the speech quality meets the predetermined speech quality requirement in response to the speech signal-to-noise ratio being greater than the predetermined speech signal-to-noise ratio threshold.

In some embodiments, the method further includes: obtaining one or more prestored reference speech features; and retrieving a reference speech feature matching the speech feature from the one or more prestored reference speech features.

In some embodiments, the method further includes: in response to the reference speech feature matching the speech feature not being retrieved, creating a new reference speech feature by using the speech feature of the current audio input signal; and enhancing the speech portion in the current audio input signal by using the speech feature of the speech portion in the current audio input signal.

In some embodiments, the method further includes: comparing a duration of the current audio input signal with a predetermined duration threshold; and creating, in response to the duration of the current audio input signal being greater than the predetermined duration threshold, a reference speech feature by using the speech feature of the current audio input signal.

In some embodiments, the method further includes: comparing the speech quality of the current audio input signal with a speech quality corresponding to the matching reference speech feature in response to the reference speech feature matching the speech feature being retrieved; updating, in response to the speech quality of the current audio input signal being superior to the speech quality corresponding to the matching reference speech feature, the matching reference speech feature by using the speech feature of the current audio input signal; and enhancing the speech portion in the current audio input signal by using the speech feature of the speech portion in the current audio input signal.

In some embodiments, the method further includes: enhancing, in response to the speech quality of the current audio input signal not being superior to the speech quality corresponding to the matching reference speech feature, the speech portion in the current audio input signal by using the speech feature of the speech portion in the current audio input signal and the matching reference speech feature.

In some embodiments, the method further includes: enhancing, in response to the reference speech feature matching the speech feature not being retrieved and the speech quality not meeting the predetermined speech quality requirement, the speech portion in the current audio input signal by using the speech feature of the speech portion in the current audio input signal.

In some embodiments, the method further includes: enhancing, in response to the reference speech feature matching the speech feature being retrieved and the speech quality not meeting the predetermined speech quality requirement, the speech feature by using the speech feature of the speech portion in the current audio input signal and the matching reference speech feature.

In some embodiments, the speech feature includes a pitch period or a Mel-frequency cepstral coefficient.

In some embodiments, the determining the speech feature of the speech portion in the current audio input signal includes: determining a speech enhancement feature and a speech comparison feature of the speech portion in the current audio input signal, wherein the speech enhancement feature includes more feature information than the speech comparison feature.

According to another aspect of this application, a speech enhancement device is further provided. The device includes a non-transitory computer storage medium storing thereon one or more instructions executable by a processor to perform the foregoing aspects.

According to still another aspect of this application, a non-transitory computer storage medium is further provided. The storage medium stores thereon one or more instructions executable by a processor to perform the foregoing aspects.

The foregoing description is an overview of this application, and details may be simplified, summarized, and omitted. Therefore, a person skilled in the art should learn that this part is merely illustrative and is not intended to limit the scope of this application in any manner. This Summary is not intended to determine key features or necessary features of the claimed subject matter, nor is it intended to be used as an aid in determining the scope of the claimed subject matter.

### BRIEF DESCRIPTION OF DRAWINGS

The foregoing and other features of content of this application may be more fully clearly understood from the following description and the appended claims in combination with the accompanying drawings. It may be understood that the accompanying drawings only depict several implementations of the content of this application, and therefore are not to be construed as limiting the scope of the content of this application. The content of this application will be described more clearly and in detail by using the accompanying drawings.

FIG. 1 is a flowchart 100 of a speech enhancement method according to an embodiment of this application; and

FIG. 2 is a flowchart 200 of a speech enhancement method according to an embodiment of this application.

### DETAILED DESCRIPTION OF THE INVENTION

In the following detailed description, reference is made to the accompanying drawings forming a part of this specification. In the accompanying drawings, similar symbols usually denote similar components, unless otherwise specified in context. The illustrative implementations described in the detailed description, the accompanying drawings, and the claims are not intended to constitute a limitation. Other implementations may be used, and other changes may be made without departing from the spirit or scope of the subject matter of this application. It may be understood that various aspects of the content of this application generally described in this application and illustrated in the accompanying drawings may be configured various different compositions, replaced, combined, and designed, and all processing clearly forms a part of the content of this application.

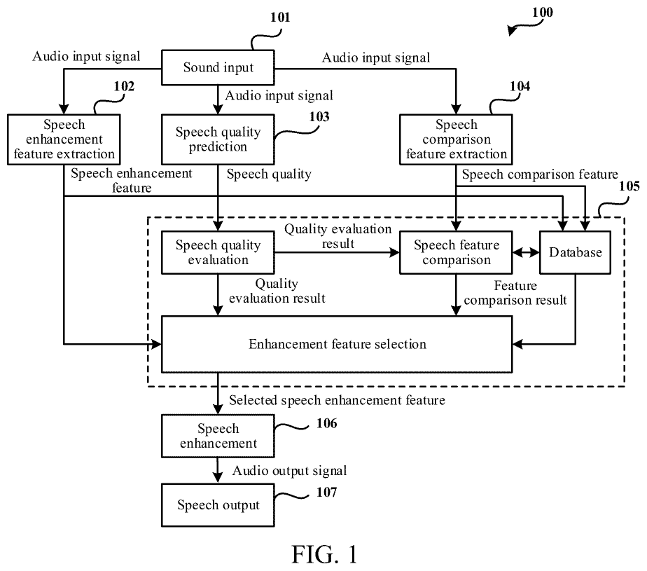

FIG. 1 is a flowchart 100 of a speech enhancement method according to an embodiment of this application. It may be understood that, a speech enhancement method 100 in this application may be applied to various audio devices, and is implemented as a speech enhancement device coupled to the audio device or integrated into the audio device. The audio device may be, for example, a hearing assistance device, or an electronic device such as a headset or a mobile communication terminal having an audio collection and/or audio output function.

As shown in FIG. 1, in step 101, an audio input signal is received by a sound input of a speech enhancement device. For example, the speech enhancement device may be configured or integrated into a speech processing device having a microphone, such as a Bluetooth headset, a hearing aid, or a headset, so that the microphone of the device may be configured to collect an environmental sound and generate an audio input signal. Further, the audio input signal may be provided to the sound input of the speech enhancement device. In some other examples, the sound input of the speech enhancement device may alternatively be communicatively coupled to another speech device, such as a separate microphone or microphone, in a wired or wireless manner, and an audio input signal is received from the speech device. Depending on an environment in which the audio input signal is collected, the audio input signal may include a speech portion including a speech and a non-speech portion including a background sound, and intensity ratios between the two portions may be different. The background sound is usually some sound in the environment, and the sound may not be desired to be amplified or enhanced. The speech is a sound made by a person or some persons, and is generally expected to be amplified. It may be understood that, the speech enhancement method in the embodiments of this application is to enhance the speech portion, i.e. human voice, in the audio input signal.

Generally, in addition to usual speech features such as sound intensity, loudness, and pitch, speeches made by different people have different features, or in other words, different speech features. Therefore, a speech signal includes speech features, and the speech features may be represented by using different parameters. For example, both a pitch period and a Mel-scale Frequency cepstral coefficient (MFCC) may be generally used as speech features to represent the speech characteristics of different people. Specifically, the pitch period reflects a time interval between two consecutive times of opening and closing of a glottis or a frequency of opening and closing, and therefore the pitch period is an important feature for describing a speech excitation source. A shape of a sound track can accurately represent a phoneme generated by the sound track. The shape of the sound track is represented in a form of an envelope of a short-time power spectrum, and the envelope may be represented by using the MFCC. Therefore, the MFCC may also be used as a speech feature to distinguish different speeches. A person skilled in the art may understand that other suitable feature parameters or a combination of these feature parameters may also be used for representing the speech feature described herein.

Correspondingly, in step 102, a speech enhancement feature of the speech portion in the audio input signal is extracted and determined by a speech enhancement feature extraction unit. The speech enhancement feature extraction unit may be coupled to the sound input, to receive the audio input signal.

In some embodiments, a deep learning algorithm may be used to extract the speech enhancement feature of the speech portion in the audio input signal. For example, a neural network model may be constructed and trained, and speech features such as a pitch period and/or an MFCC of a speech signal in the audio input signal are extracted through the neural network model. In some other embodiments, the audio input signal may alternatively be processed in another manner to extract the speech enhancement feature. For example, to extract the MFCC, an original audio input signal may be pre-emphasized by a high-pass filter to improve a high-frequency portion, and then processed by performing framing, windowing, and fast Fourier transform to obtain a power spectrum of each frame of signal. Then, Mel filtering, a logarithmic energy operation, and discrete cosine transform (DCT) may be performed, to obtain the required MFCC. It may be understood that the foregoing algorithm for extracting the speech enhancement feature is merely exemplary, and a person skilled in the art may select different feature extraction manners based on characteristics of speech features to be extracted and available hardware resources.

It may be understood that, the speech enhancement feature extracted by the speech enhancement feature extraction unit is subsequently used for enhancement on the speech signal. Therefore, preferably, the speech enhancement feature may include more feature information.

Still referring to FIG. 1, in step 103, a speech quality of the audio input signal is determined by a speech quality prediction unit. Similarly, the speech quality prediction unit may be coupled to the sound input, to receive the audio input signal.

As described in the background section of this application, the speech quality also has significant impact on speech recognition, and it may be difficult to extract sufficient features for speech enhancement from a speech signal with a poor quality. Therefore, the speech enhancement method in the embodiments of this application further determines the quality of the speech signal.

The speech quality may be represented by using various suitable parameters. In an embodiment, the speech quality may be determined by determining a speech signal-to-noise ratio p-SNR of the audio input signal. Specifically, the speech signal-to-noise ratio represents a ratio of an average power of the speech portion to an average power of the non-speech portion. In an embodiment, the speech signal-to-noise ratio p-SNR of the audio input signal may be predicted by using an energy-based prediction method, a cepstrum-based prediction method, or a deep learning method.

Further, the speech signal-to-noise ratio p-SNR of the audio input signal may be compared with a predetermined speech signal-to-noise ratio threshold t-SNR, to evaluate the speech quality. Specifically, if the speech signal-to-noise ratio p-SNR is greater than the predetermined threshold t-SNR, it may be deemed that the audio input signal includes sufficient or strong enough speech portions, which may meet a predetermined speech quality requirement. Otherwise, it is deemed that the audio input signal does not meet a predetermined speech quality requirement. After determining whether the speech signal-to-noise ratio is greater than the speech signal-to-noise ratio threshold, an operation (for example, a read or storage operation) may be further performed on the audio input signal. Details may refer to the descriptions of step 105 followed. In an embodiment, the predetermined speech signal-to-noise ratio threshold t-SNR may be equal to 0.5, but a person skilled in the art may set t-SNR to another value based on an actual requirement, for example, a value in a range of 0.3 to 0.6., which is not limited in this application.

It may be understood that, although in step 103, for example, the speech quality is determined by determining the speech signal-to-noise ratio of the audio input signal, in other embodiments, the speech quality may alternatively be evaluated and determined by using another parameter such as a degree of speech recognition. In addition, in other embodiments, in addition to using relative intensity of the speech portion relative to the non-speech portion (that is, the speech signal-to-noise ratio), the speech quality of the audio input signal may alternatively be determined by determining absolute intensity of the speech portion or absolute intensity of the non-speech signal in the audio input signal, which may be adjusted by a person skilled in the art based on an actual situation.

As described above, the inventor of this application found that, during speech enhancement, if known speech features (usually extracted in a quiet or ideal environment) can be used for assisting speech enhancement on a currently received speech signal, a speech enhancement effect is significantly improved. To determine which feature information of the known speech corresponds to the current speech signal, the speech enhancement method 100 further includes step 104 for comparison feature extraction.

Specifically, in step 104, a speech comparison feature of the speech portion in the audio input signal is extracted by a speech comparison feature extraction unit, for comparison with one or more prestored reference speech features in step 105.

Similarly, similar to extraction on the speech enhancement feature of the speech portion in the audio input signal in step 102, in step 104, a deep neural network model may be constructed and trained by using, for example, the deep learning algorithm, and the speech comparison feature in the speech portion is determined by extracting parameters such as the pitch period, the MFCC, and Filter Bank, for subsequent speech feature comparison in step 105. In an embodiment, the speech enhancement feature extracted in step 102 and the speech comparison feature extracted in step 104 may be at least partially different. In an embodiment, to save processing resources, the speech comparison feature may have less feature information, for example, less feature information than that included in the speech enhancement feature. For example, the speech comparison feature extracted in step 104 may be a speech feature, that is, a voiceprint feature used in a speaker identification (or referred to as Voice ID for short) technology. While the speech enhancement feature may include, in addition to a Voice ID, features such as the MFCC and Filter Bank. In some other embodiments, the speech comparison feature and the speech enhancement feature have same features. In addition, the speech comparison feature and the speech enhancement feature may also have completely different features. For example, the speech enhancement feature may be the MFCC, and the speech comparison feature may be, for example, an identity vector (I-vector) mapped in a total factor matrix. The speech enhancement feature usually does not include the I-vector.

It is to be noted that, although two independent steps are shown in FIG. 1, namely, step 102 (extracting the speech enhancement feature for a speech enhancement algorithm) and step 104 (extracting the speech comparison feature for speech comparison) for extracting feature information in human voice, a person skilled in the art may understand that the speech enhancement feature for the speech enhancement algorithm extracted in step 102 may also be the same as the speech comparison feature for speech comparison extracted in step 104. In other words, in some embodiments, step 102 and step 104 may be a same step, and the speech enhancement feature extraction unit and the speech comparison feature extraction unit may also be a same unit.

In some embodiments, the speech comparison feature may be represented as a vector having a length of N. The feature vector may be compared with a vector of a reference speech feature prestored in a database in subsequent step 105. The two types of vectors may have the same or similar formats.

Specifically, in step 105, a speech feature comparison unit compares a speech comparison feature vector extracted in step 104 with one or more prestored reference speech feature vectors. Further, whether a person represented by the speech comparison feature vector is a person known in the database may be determined based on a result of comparison between the two types of vectors.

In an embodiment, the speech comparison feature vector and the reference speech feature vector may be compared by using a similarity calculation algorithm such as a cosine distance algorithm. That is, a reference speech feature vector stored in the predetermined database having a minimum distance (that is, a highest similarity) to the extracted speech comparison feature vector is matched through retrieval. Specifically, the cosine distance algorithm would first calculate a cosine value (a cosine similarity) between a to-be-compared speech comparison feature vector and the reference speech feature vector, which is represented by, for example, Equation (1).

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad ( 1 )$$

cos (θ) represents the cosine value between the two feature vectors, A represents the to-be-compared speech comparison feature vector, B represents the reference speech feature vector, and n indicates a dimension (which is a natural number) of the two feature vectors. Then, the cosine distance is obtained by calculating (1-cos (θ) A).

It may be understood that, during actual application, a plurality of reference speech feature vectors may be compared with the speech comparison feature vector respectively, and a reference speech feature vector having a minimum distance to the speech comparison feature is used as a matching vector of the speech comparison feature vector, and the minimum distance is set as d-cos. Although the method of calculating the similarity between the two vectors is described above by using the cosine distance as an example, a person skilled in the art may alternatively use another suitable similarity calculation method, such as Euclidean distance, for calculating the similarity between the feature vectors. This is not limited in this application.

Further, the minimum distance d-cos determined after the comparison may be compared with a preset distance threshold t-cos, wherein the preset distance threshold t-cos may be a value determined according to experience or history data, and is used for determining whether the speech comparison feature and the reference speech feature are from the same person. In an embodiment, when the minimum distance d-cos is less than or equal to the distance threshold t-cos, it indicates that a similarity between the speech comparison feature and a reference speech feature is high. In this case, it may be determined that the reference speech feature matching the speech signal in the audio input signal exists in the database, that is, a transmitter of the speech signal in the currently received audio input signal is already recorded in an existing database. On the contrary, when the minimum distance d-cos is greater than the distance threshold t-cos, it indicates that similarities between the speech comparison feature and all the reference speech features are not high enough. In this case, it is determined that the reference speech feature matching the speech signal in the audio input signal does not exist in the predetermined database, that is, the transmitter of the speech signal in the currently received audio input signal is not recorded in the existing database.

Still referring to FIG. 1, in step 105, a speech quality evaluation unit evaluates the speech quality (for example, the speech signal-to-noise ratio p-SNR) determined in step 103, and generates a quality evaluation result. As described above, the speech signal-to-noise ratio p-SNR of the audio input signal may be compared with the predetermined speech signal-to-noise ratio threshold t-SNR, to evaluate the speech quality. Then, the quality evaluation result and a feature comparison result generated by the speech feature comparison unit may be provided to an enhancement feature selection unit for subsequent operations. Based on the feature comparison result and the speech quality evaluation result, step 105 may generally include 4 different cases and processing manners.

In a first case, if the speech signal-to-noise ratio p-SNR of the audio input signal determined in step 103 is greater than the predetermined speech signal-to-noise ratio threshold t-SNR and the minimum distance d-cos determined in step 105 is greater than a minimum distance threshold t-cos (that is, p-SNR>t-SNR, and d-cos>t-cos), it may be considered that the current audio input signal includes strong enough human voice, the speech quality of the current audio input signal meets the predetermined speech quality requirement, and there is no similar enough reference speech feature in the database of the speech enhancement device. It indicates that the inputted current audio input signal may include new human voice. In this case, a new reference speech feature may be created in the database for comparison and enhancement on an audio input signal inputted later.

In some embodiments, a storage format of a reference speech feature stored by the speech enhancement device in its database may be: [timestamp; ID; p-SNR; speech comparison feature vector; speech enhancement feature vector]. Herein, the timestamp represents storage time of the reference speech feature in the database; ID represents a serial number of the reference speech feature; p-SNR represents a speech signal-to-noise ratio of the reference speech feature; the speech comparison feature vector represents a speech feature vector of the reference speech feature for comparison; and the speech enhancement feature vector represents a speech feature vector of the reference speech feature for speech enhancement. In some examples, a storage length of each reference speech feature may be equal to a length of the speech comparison feature vector plus a length of the speech enhancement feature vector plus 3 (where a byte is used as a unit, and the three more bytes may be used for storing data of the timestamp, ID, and p-SNR). It may be understood that, the reference speech feature may also be in another storage format. For example, when the speech comparison feature vector and the speech enhancement feature vector are the same vector, the storage format may only include information of the timestamp, ID, p-SNR, and the speech comparison (enhancement) feature vector.

Still referring to FIG. 1, in the first case, in step 106, the enhancement feature selection unit may select the speech enhancement feature extracted in step 102 and input the speech enhancement feature to a speech enhancement algorithm unit, and perform speech enhancement on the audio input signal by using the speech enhancement feature. In other words, since there is previously no reference speech feature corresponding to the audio input signal in the database, and the speech quality of the audio input signal meets a requirement, the speech enhancement feature extracted in step 102 may be used as a reference speech feature required for speech enhancement. At the same time, the speech enhancement feature may also be stored in the database for subsequent processing as the reference speech feature. In an embodiment, the speech enhancement algorithm used by the speech enhancement algorithm unit may be in a form of a neural network, for example, a convolutional neural network (CNN), a recursive neural network (RNN), or a convolutional-recursive neural network (CRN). A person skilled in the art may understand that speech enhancement algorithms based on various features may be used, and this application is not limited thereto.

In a second case, if the speech signal-to-noise ratio p-SNR of the audio input signal determined in step 103 is greater than the predetermined speech signal-to-noise ratio threshold t-SNR and the minimum distance d-cos determined in step 105 is less than a minimum distance threshold t-cos (that is, p-SNR>t-SNR, and d-cos<t-cos), it may be considered that the current audio input signal includes strong enough human voice, and the existing database also includes the reference speech feature with a high enough similarity to the audio input signal. Therefore, it is possible to use the reference speech feature stored in the database for speech enhancement.

In this case, p-SNR of the audio input signal may be further compared with p-SNR of the matching reference speech feature in the database. If p-SNR of the audio input signal is less than p-SNR of the matching reference speech feature in the database, it may be considered that the speech quality of the current speech input signal is inferior to a speech quality of the matching reference speech feature when stored. Correspondingly, in some embodiments, a speech enhancement feature in the matching reference speech feature may be read in step 106, and the speech enhancement feature of the audio input signal extracted in step 102 is combined, and these two jointly enhance the currently processed speech input signal. In some other embodiments, only the speech enhancement feature in the matching reference speech feature in the database read in step 106 may be used to enhance the currently processed speech input signal. On the contrary, if p-SNR of the audio input signal is greater than p-SNR of the matching reference speech feature in the database, it may be considered that the speech quality of the current speech input signal is superior to the speech quality of the matching reference speech feature when stored. Correspondingly, in step 105, the matching reference speech feature in the database may be updated by using the speech feature of the current audio input signal for subsequent speech feature matching and enhancement. In some embodiments, additionally or alternatively, a duration of the current audio input signal may be compared with a predetermined duration threshold, and the reference speech feature is updated based on a duration comparison result and/or the quality evaluation result. In addition, in step 106, the enhancement feature selection unit may directly use the speech enhancement feature of the audio input signal extracted in step 102 to enhance the current speech input signal. Then, in step 107, an enhanced audio output signal may be outputted, for example, played through a microphone.

In a third case, if the speech signal-to-noise ratio p-SNR of the audio input signal determined in step 103 is less than the predetermined speech signal-to-noise ratio threshold t-SNR and the minimum distance d-cos determined in step 105 is greater than a minimum distance threshold t-cos (that is, p-SNR<t-SNR, and d-cos>t-cos), it may be considered that the current audio input signal does not include strong enough human voice, and the existing database also does not include the reference speech feature that is similar enough. In this case, in step 106, only the speech enhancement feature of the audio input signal extracted in step 102 is used to enhance the current speech input signal. Then, in step 107, an enhanced audio output signal may be outputted.

In a fourth case, if the speech signal-to-noise ratio p-SNR of the audio input signal determined in step 103 is less than the predetermined speech signal-to-noise ratio threshold t-SNR and the minimum distance d-cos determined in step 105 is less than a minimum distance threshold t-cos (that is, p-SNR<t-SNR, and d-cos<t-cos), it may be considered that the current audio input signal does not include strong enough human voice, but the existing database includes the reference speech feature that is similar enough. In this case, a speech enhancement feature of the matching reference speech feature in the database may be read in step 106, and the speech enhancement feature of the audio input signal extracted in step 102 is combined, and these two jointly enhance the currently processed speech input signal by using the two speech enhancement features. In some other embodiments, only the speech enhancement feature of the audio input signal extracted in step 102 may be used to enhance the current speech input signal. Then, in step 107, an enhanced audio output signal may be outputted.

As can be learned, based on the foregoing method, when a speech in the speech input signal needs to be enhanced, the speech portion of the current speech input signal may be enhanced based on the matching reference speech features in the existing database. These matching reference speech features are usually collected in the quiet environment. Therefore, the method of this application can effectively improve the speech enhancement effect.

In addition, during actual use, reference feature data in the database may also be continuously updated as usage duration increases. Feature data collected in the ideal environment may be stored in the database, so that the database can usually store feature data with a high speech quality. This further improves an effect of subsequent speech enhancement.

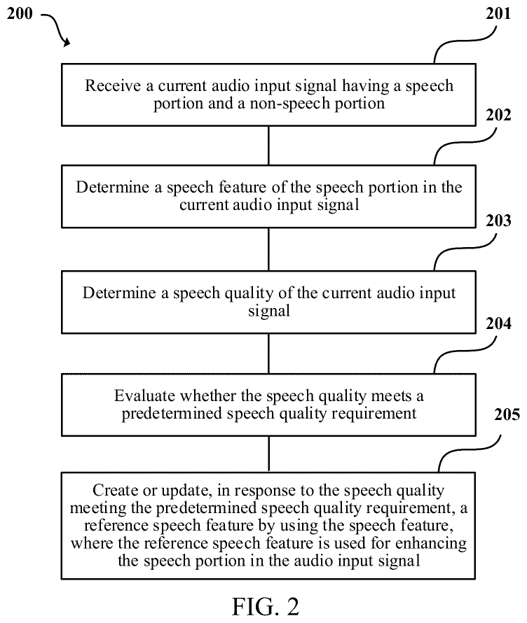

FIG. 2 is a flowchart 200 of a speech enhancement method according to an embodiment of this application. One or more steps in the flowchart 200 may be implemented in a manner similar to the same or similar steps in the method 100 shown in FIG. 1, and may be performed by a processing device. The processing device may be an electronic device having a speech signal processing capability, for example, a hearing assistance device with a processor or an earphone.

As shown in FIG. 2, the method starts with step 201, the processing device may receive a current audio input signal having a speech portion and a non-speech portion. Then, in step 202, the processing device may determine a speech feature of the speech portion in the current audio input signal, and in step 203, the processing device may determine a speech quality of the current audio input signal. In this way, in step 204, the processing device may evaluate whether the speech quality meets a predetermined speech quality requirement. Then, in step 205, in response to an evaluation result in step 204, that is, the speech quality meeting the predetermined speech quality requirement, the processing device may create or update a reference speech feature by using the speech feature, where the reference speech feature is used for enhancing the speech portion in the audio input signal.

As can be seen from the above, through the foregoing method, a reference speech feature stored in a speech feature database may be created or updated, so that as an actual usage duration increases, a reference speech feature with a better quality is reserved.

In some embodiments, after step 205, a speech enhancement method 200 further includes: the step of performing speech enhancement on a currently inputted audio input signal by using the reference speech feature. For example, a reference speech feature matching the speech feature of the speech portion in the current audio input signal may be retrieved from one or more prestored reference speech features, so that one or two of the speech feature of the speech portion in the current audio input signal and the matching reference speech feature may be used to enhance the speech portion in the current audio input signal. In particular, when the speech quality of the current audio input signal is not superior to a speech quality corresponding to the matching reference speech feature, the matching reference speech feature may be used to enhance the speech portion in the current audio input signal. Alternatively, when the speech quality of the current audio input signal is superior to a speech quality corresponding to the matching reference speech feature, the matching reference speech feature in the database may be updated by using the speech feature of the speech portion in the current audio input signal, and at the same time, speech enhancement may be performed on the current audio input signal by using the updated reference speech feature.

In some embodiments, this application further provides some computer program products, including non-transitory computer-readable storage media. The non-transitory computer-readable storage medium includes computer-executable code used for performing steps in the method embodiment shown in FIG. 1 or FIG. 2. In some embodiments, the computer program product may be stored in a hardware, for example, an audio device.

For example, the embodiments of the present invention may be implemented by hardware, software, or a combination of software and hardware. The hardware part can be implemented by using dedicated logic; and the software part can be stored in a memory and executed by an appropriate instruction execution system such as a microprocessor or dedicated design hardware. A person of ordinary skill in the art may understand that the foregoing device and method may be implemented by using computer-executable instructions and/or included in processor control code, and such code is provided by, for example, a carrier media such as a disk, a CD or a DVD-ROM, a programmable memory such as a read-only memory (firmware), or a data carrier such as an optical or electronic signal carrier. The device and modules thereof in the present invention may be implemented by a hardware circuit of a very large-scale integrated circuit or gate array, a semiconductor such as a logic chip or a transistor, or a programmable hardware device such as a field programmable gate array or a programmable logic device, or may be implemented by software executed by various types of processors, or may be implemented by a combination of the foregoing hardware circuit and software, for example, firmware.

It is to be noted that although steps or modules in the speech enhancement method, device, and storage medium are mentioned in detailed descriptions above, such division is merely an example but not mandatory. Actually, according to the embodiments of this application, the features and functions of two or more modules described above may be embodied in one module. Conversely, the features or functions of one module described above may be further divided and embodied by a plurality of modules.

A person of ordinary skill in the art may understand and implement other changes to the disclosed implementations by studying the specification, the disclosed content, the accompanying drawings, and the appended claims. In the claims, the term “comprising” does not exclude other elements and steps, and the term “a” or “an” does not exclude a plurality. During actual application of this application, one part may perform functions of a plurality of technical features cited in the claims. Any reference numerals in the claims should not be construed as a limitation on the scope.

1. A speech enhancement method, comprising:
receiving a current audio input signal having a speech portion and a non-speech portion;
determining a speech feature of the speech portion in the current audio input signal;
determining a speech quality of the current audio input signal;
evaluating whether the speech quality meets a predetermined speech quality requirement; and
creating or updating, in response to the speech quality meeting the predetermined speech quality requirement, a reference speech feature by using the speech feature, wherein the reference speech feature is used for enhancing the speech portion in an audio input signal.

2. The method according to claim 1, wherein the determining the speech quality of the current audio input signal comprises:
determining a speech signal-to-noise ratio of the current audio input signal, wherein the speech signal-to-noise ratio represents a ratio of a power of the speech portion to a power of the non-speech portion.

3. The method according to claim 2, wherein the evaluating whether the speech quality meets the predetermined speech quality requirement comprises:
comparing the speech signal-to-noise ratio with a predetermined speech signal-to-noise ratio threshold; and
determining, in response to the speech signal-to-noise ratio being greater than the predetermined speech signal-to-noise ratio threshold, that the speech quality meets the predetermined speech quality requirement.

4. The method according to claim 1, further comprising:
obtaining one or more prestored reference speech features; and
retrieving the reference speech feature matching the speech feature from the one or more prestored reference speech features.

5. The method according to claim 4, further comprising:
creating, in response to the reference speech feature matching the speech feature not being retrieved, a new reference speech feature by using the speech feature of the current audio input signal; and
enhancing the speech portion in the current audio input signal by using the speech feature of the speech portion in the current audio input signal.

6. The method according to claim 5, further comprising:
comparing a duration of the current audio input signal with a predetermined duration threshold; and
creating, in response to the duration of the current audio input signal being greater than the predetermined duration threshold, a reference speech feature by using the speech feature of the current audio input signal.

7. The method according to claim 4, further comprising:
comparing, in response to the reference speech feature matching the speech feature being retrieved, the speech quality of the current audio input signal with a speech quality corresponding to the matching reference speech feature;
updating, in response to the speech quality of the current audio input signal being superior to the speech quality corresponding to the matching reference speech feature, the matching reference speech feature by using the speech feature of the current audio input signal; and
enhancing the speech portion in the current audio input signal by using the speech feature of the speech portion in the current audio input signal.

8. The method according to claim 7, further comprising:
enhancing, in response to the speech quality of the current audio input signal not being superior to the speech quality corresponding to the matching reference speech feature, the speech portion in the current audio input signal by using the speech feature of the speech portion in the current audio input signal and the matching reference speech feature.

9. The method according to claim 4, further comprising:
enhancing, in response to the reference speech feature matching the speech feature not being retrieved and the speech quality not meeting the predetermined speech quality requirement, the speech portion in the current audio input signal by using the speech feature of the speech portion in the current audio input signal.

10. The method according to claim 4, further comprising:
enhancing, in response to the reference speech feature matching the speech feature being retrieved and the speech quality not meeting the predetermined speech quality requirement, the speech feature by using the speech feature of the speech portion in the current audio input signal and the matching reference speech feature.

11. The method according to claim 1, wherein the speech feature comprises a pitch period or a Mel-frequency cepstral coefficient.

12. The method according to claim 1, wherein the determining the speech feature of the speech portion in the current audio input signal comprises:
determining a speech enhancement feature and a speech comparison feature of the speech portion in the current audio input signal,
wherein the reference speech feature comprises a reference speech enhancement feature and a reference speech comparison feature, the speech enhancement feature and the reference speech enhancement feature being used for enhancing the speech portion of the audio input signal, and the speech comparison feature being used for matching the reference speech comparison feature.

13. A speech enhancement device comprising a non-transitory computer storage medium storing one or more executable instructions executed by a processor to perform the following steps:
receiving a current audio input signal having a speech portion and a non-speech portion;
determining a speech feature of the speech portion in the current audio input signal;
determining a speech quality of the current audio input signal;
evaluating whether the speech quality meets a predetermined speech quality requirement; and
creating or updating, in response to the speech quality meeting the predetermined speech quality requirement, a reference speech feature by using the speech feature, wherein the reference speech feature is used for enhancing the speech portion in an audio input signal.

14. A non-transitory computer storage medium storing one or more executable instructions executed by a processor to perform the following steps:
receiving a current audio input signal having a speech portion and a non-speech portion;
determining a speech feature of the speech portion in the current audio input signal;
determining a speech quality of the current audio input signal;
evaluating whether the speech quality meets a predetermined speech quality requirement; and
creating or updating, in response to the speech quality meeting the predetermined speech quality requirement, a reference speech feature by using the speech feature, wherein the reference speech feature is used for enhancing the speech portion in an audio input signal.

15. A speech enhancement method, comprising:
receiving a current audio input signal having a speech portion and a non-speech portion;
determining a speech feature of the speech portion in the current audio input signal;
determining a speech quality of the current audio input signal;
evaluating whether the speech quality meets a predetermined speech quality requirement;
retrieving a reference speech feature matching the speech feature from one or more prestored reference speech features; and
enhancing, in response to an evaluation result for the predetermined speech quality requirement and a matching result for the one or more reference speech features, the speech portion in the current audio input signal by using one or two of the speech feature of the speech portion in the current audio input signal and the matching reference speech feature.

16. The method according to claim 15, further comprising:
in response to the speech quality meeting the predetermined speech quality requirement and the reference speech feature matching the speech feature not being retrieved, enhancing the speech portion in the current audio input signal by using the speech feature of the speech portion in the current audio input signal, and creating a new reference speech feature by using the speech feature of the current audio input signal.

17. The method according to claim 15, further comprising:
comparing, in response to the speech quality meeting the predetermined speech quality requirement and the reference speech feature matching the speech feature being retrieved, the speech quality of the current audio input signal with a speech quality of the matching reference speech feature;
updating, in response to the speech quality of the current audio input signal being superior to the speech quality of the matching reference speech feature, the matching reference speech feature by using the speech feature of the current audio input signal; and
enhancing the speech portion in the current audio input signal by using the speech feature of the speech portion in the current audio input signal.

18. The method according to claim 17, further comprising:
enhancing, in response to the speech quality of the current audio input signal not being superior to the speech quality of the matching reference speech feature, the speech portion in the current audio input signal by using the speech feature of the speech portion in the current audio input signal and the matching reference speech feature.

19. The method according to claim 15, further comprising:
enhancing, in response to the speech quality not meeting the predetermined speech quality requirement and the reference speech feature matching the speech feature not being retrieved, the speech portion in the current audio input signal by using the speech feature of the speech portion in the current audio input signal.

20. The method according to claim 15, further comprising:
enhancing, in response to the speech quality not meeting the predetermined speech quality requirement and the reference speech feature matching the speech feature being retrieved, the speech feature by using the speech feature of the speech portion in the current audio input signal and the matching reference speech feature.

21. The method according to claim 15, wherein the determining the speech feature of the speech portion in the current audio input signal comprises:
determining a speech enhancement feature and a speech comparison feature of the speech portion in the current audio input signal,
wherein the reference speech feature comprises a reference speech enhancement feature and a reference speech comparison feature, the speech enhancement feature and the reference speech enhancement feature being used for enhancing the speech portion of the audio input signal, and the speech comparison feature being used for matching the reference speech comparison feature.

22. A speech enhancement method, comprising:
receiving a current audio input signal having a speech portion and a non-speech portion;
determining a speech feature of the speech portion in the current audio input signal, wherein the speech feature comprises a speech enhancement feature and a speech comparison feature;
determining a speech quality of the current audio input signal;
evaluating whether the speech quality meets a predetermined speech quality requirement;
obtaining one or more prestored reference speech features, each comprising a reference speech enhancement feature and a reference speech comparison feature;
retrieving, based on comparison between the speech comparison feature and the reference speech comparison feature, a reference speech feature matching the speech feature from the one or more prestored reference speech features; and
enhancing, in response to an evaluation result for the predetermined speech quality requirement and a matching result for the one or more reference speech features, the speech portion in the current audio input signal by using one or two of the speech enhancement feature of the speech portion in the current audio input signal and the reference speech enhancement feature of the matching reference speech feature.
